(19) United States
(12) Patent Application Publication
(10) Pub. No.: US 2021/0397141 A1
(43) Pub. Date: Dec. 23, 2021

(54) CHARGING KIT AND METHOD THEREFOR

(71) Applicant: ETA SA Manufacture Horlogère Suisse, Grenchen (CH)

(72) Inventors: Romain BESUCHET, Yverdon-les-Bains (CH); José NOIRJEAN, Montfaucon (CH)

(73) Assignee: ETA SA Manufacture Horlogère Suisse, Grenchen (CH)

(21) Appl. No.: 17/242,528

(22) Filed: Apr. 28, 2021

(30) Foreign Application Priority Data
Jun. 17, 2020 (EP) 20180587.6

(51) Int. Cl. G04G 21/02; G09G 5/38; G04C 10/00; G04G 19/00

(52) U.S. Cl. CPC G04G 21/02; G04G 19/00; G04C 10/00; G09G 5/38

(57) ABSTRACT

A display permutation method (500) implemented by a display device (100) for detecting the passage between a first orientation (131) of said display device (100) and a second orientation (132) of said display device (100) so as to permute at least one first indicator (110) between at least one first operating mode (101) and at least one second operating mode (102), and at least one digital display (140) between at least one first display mode (141) and at least one second display mode (142).

### CROSS REFERENCE TO RELATED APPLICATION

This application is claiming priority based on European Patent Application No. 20180587.6 filed on Jun. 17, 2020, the disclosure of which is incorporated herein in its entirely by reference.

### TECHNICAL FIELD

The present invention relates to connected watches, and particularly charging kits for connected watches.

### TECHNOLOGICAL BACKGROUND

Very often when watches, in particular connected watches are recharged the screen turns off or indicates the charge level of the battery. In order to know the time, a small manipulation should be carried out so that the watch may display the time.

### SUMMARY OF THE INVENTION

The present invention proposes to resolve all or part of these drawbacks thanks to a display device comprising at least one first operating mode, at least one second operating mode, and at least:
One first indicator; said at least one first indicator being configured to indicate the hour in at least one first primary position according to said at least one first operating mode and in at least one second primary position according to
One detection member; said at least one detection member being configured to detect the passage between a first orientation of said display device and a second orientation of said display device; and
One permutation unit; said at least one permutation unit being configured to permute said at least one first indicator between said at least one first operating mode and said at least one second operating mode, when said at least one detection member detects the passage between said first orientation and said second orientation.

Thanks to this arrangement, when said display device changes orientation, in particular when said display device is placed on a charging station, the user may read the time during the charging.

According to one embodiment, said display device comprises at least one digital display comprising at least one first display mode in said first orientation and at least one second display mode in said second orientation and wherein said at least one permutation unit being configured to permute said at least one digital display between said at least one first display mode and said at least one second display mode, when said at least one detection member detects the passage between said first orientation and said second orientation.

Thanks to this arrangement, when said display device changes orientation, in particular when said display device is placed on a charging station, said at least one digital display makes it possible to permute between different displays so that the user may know the orientation of said watch and therefore read the time easily during the charging.

According to one embodiment, said at least one digital display is configured to display a set of indexes in said at least one second display mode in said second orientation.

Thanks to this arrangement, when said display device changes orientation, in particular when said display device is placed on a charging station, the user may know the orientation of said watch and therefore read the time easily during the charging.

According to one embodiment, said at least one detection member is an accelerometer, capacitive sensor, inductive sensor, resistive sensor, optical sensor and/or a power supply detector.

Thanks to this arrangement, said display device may detect a change of orientation and/or when it is connected to a charging station.

According to one embodiment, said at least one digital display is a LCD, OLED, LED and/or TFT screen.

Thanks to this arrangement, said display device may change display easily.

According to one embodiment, said display device comprises at least one second indicator configured to indicate the minutes in at least one first secondary position according to said at least one first operating mode and in at least one second secondary position according to said at least one second operating mode.

Thanks to this arrangement, the user may read the time easily.

According to one embodiment, said display device comprises at least one drive member configured to move said at least one first indicator and/or said at least one second indicator.

Thanks to this arrangement, said at least one first indicator and/or at least one second indicator may be moved between said at least one first operating mode and said at least one second operating mode.

According to one embodiment, said at least one permutation unit is configured to calculate the angle between said first orientation and said second orientation and to move said at least one first indicator between said at least one first primary position and said at least one second primary position depending on said angle and/or to move said at least one second indicator between said at least one first secondary position and said at least one second secondary position depending on said angle.

Thanks to this arrangement, said at least one first indicator and/or said at least one second indicator may indicate the hour and/or the minutes respectively in said first orientation and said second orientation.

The present invention relates to a watch preferably connected configured to operate according to at least one first operating mode and at least one second operating mode and comprising at least one display device according to one embodiment of the present invention.

Thanks to this arrangement, when said watch changes orientation, in particular when said watch is placed on a charging station, the user may read the time during the charging.

The present invention relates to a charging kit comprising at least one watch according to the invention and at least one charging station configured to charge or recharge said at least one watch.

Thanks to this arrangement, when said watch changes orientation, in particular when said watch is placed on a charging station, the user may read the time during the charging.

The present invention relates to a display permutation method implemented by said display device according to the invention, by said watch according to the invention and/or by the charging kit according to the invention; said display permutation method comprising:
A detection of the passage between said first orientation of said display device and said second orientation of said display device;
A permutation of said at least one first indicator between said at least one first operating mode and said at least one second operating mode.

Thanks to this arrangement, when said display device or said watch changes orientation, in particular when said display device or said watch is placed on a charging station, the user may read the time during the charging.

According to one embodiment, said permutation permutes said at least one digital display between said at least one first display mode and said at least one second display mode

According to one embodiment, said display permutation method comprises an indication of the time in said at least one first operating mode and in said at least one second operating mode.

thanks to one or other of these preceding arrangements, the user can read the time easily.

### BRIEF DESCRIPTION OF THE FIGURES

The invention will be described hereafter in more detail using the appended drawings, given by way of non-limiting examples, wherein:

FIG. 1 illustrates a display device 100 according to one embodiment of the invention; and

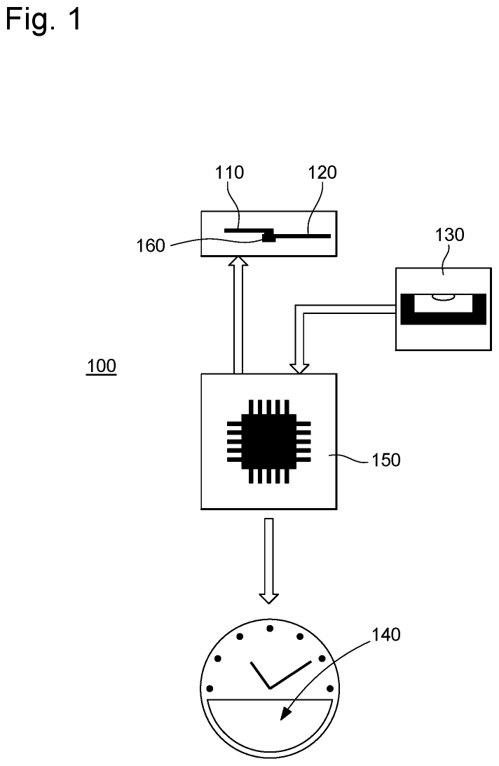

FIG. 2 illustrates a display permutation method 500 according to one embodiment of the invention.

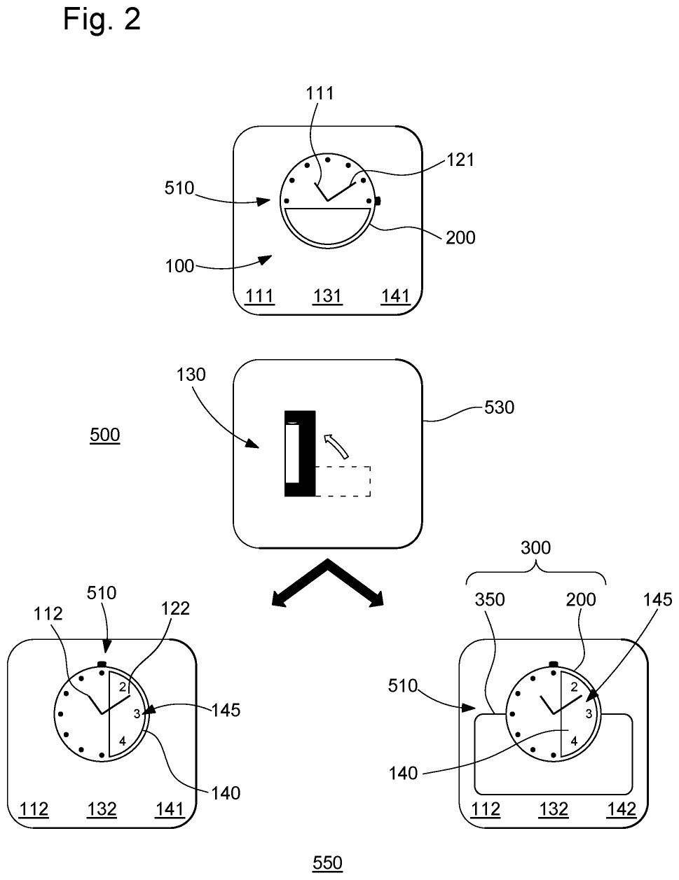

### DETAILED DESCRIPTION OF THE INVENTION

When a watch, preferably connected, is recharged, it is not obvious for the user to read the time if the orientation of the watch is 90° or 270° for example. Indeed, it is “10:10”, after orientation of the watch, the user will read “07:55” or “01:25”. This case also occurs when the user places their watch on a support such as a table or a desk.

Thanks to the present invention, this problem is resolved via a charging kit 300 comprising at least one watch 200 and at least one charging station 350 configured to charge or recharge said at least one watch 200. Said watch 200, preferably connected, comprises a display device 100 that may adapt the time depending on the orientation of said watch 200 thanks to at least one first operating mode 101 and to at least one second operating mode 102. Indeed, according to a first orientation 131, said watch 200 may operate according to said at least one first operating mode 101 and in a second orientation 132, said watch 200 may operate according to said at least one second operating mode 102.

For this, said display device 100 comprises at least one first indicator 110, at least one second indicator 120, at least one drive member 160 configured to move said at least one first indicator 110 and/or said at least one second indicator 120, at least one detection member 130, at least one digital display 140, typically a LCD, OLED, LED and/or TFT screen, and at least one permutation unit 150.

By using the preceding example, in said at least one first operating mode 101, if it is “10:10” in said first orientation 131 of said display device 100, said at least one first indicator 110 indicates the hour in at least one first primary position 111 and said at least one second indicator 120 indicates the minutes in at least one first secondary position 121 in said at least one first operating mode 101.

Of course, it is also possible that there is only said at least one first indicator 110 indicating the hour and partially the minutes, as in the “Grande Heure” model by Jaquet Droz. Said at least one digital display 140, which may be included by said display device 100 according to one embodiment, for its part may display different information in at least one first display mode 141 in said first orientation 131, such as the temperature and the date for example.

When the user desires to charge or recharge said watch 200, the latter, that is to say said watch 200 is placed on said at least one charging station 350. A crown on the periphery of said watch 200 and the bracelet may impose a certain orientation to said watch 200. This may also be the case, when the user lays said watch 200 on a bedside table or a table and instead of laying it flat, they may orient said watch 200 towards themself by allowing said watch 200 to rest on the periphery of the middle of the watch, so that said watch 200 may display the time in the manner of an alarm clock or a clock.

However, as previously mentioned, it will be difficult for the user to know if it is “07:55” or “01:25”, according to its orientation.

In this orientation, that is to say in said second orientation 132, said watch 200, implementing a display permutation method 500, detects 530 the passage between said first orientation 131 of said display device 100 and said second orientation 132 of said display device 100 via said at least one detection member 130 configured to detect 530 said passage between said first orientation 131 of said display device 100 and said second orientation 132 of said display device 100.

This detection 530, as mentioned above, is permitted by said at least one detection member 130 which may be an accelerometer 130, capacitive sensor 130, inductive sensor 130, resistive sensor 130, optical sensor 130 and/or a power supply detector 130.

When said at least one detection member 130 is an accelerometer 130, it is the earth's gravity that indicates said first orientation 131 and said second orientation 132. In the case of a capacitive sensor 130, inductive sensor 130, resistive sensor 130, optical sensor 130 and/or a power supply detector 130, it is the contact with said at least one charging station 350 that indicates that said watch 200 is on said at least one charging station 350 is therefore in said second orientation 132: said first orientation 131 being deduced from said second orientation 132.

Said at least one permutation unit 150, for its part, receives the information from said at least one detection member 130 that a change of orientation has taken place and permutes 550 between said at least one first operating mode 101 and said at least one second operating mode 102. Said at least one permutation unit 150 then calculates the angle between said first orientation 131 and said second orientation 132 and moves said at least one first indicator 110 and/or said at least one second indicator 120 between said at least one first primary position 111 and at least one second primary position 112 depending on said angle and/or between said at least one first secondary position 121 and at least one second secondary position 122 respectively depending on said angle. For example, if it is “10:10”, said at least one first indicator 110 indicates the index “10” approximatively in said at least one first primary position 111 and/or said at least one second indicator 120 indicates the index “2” in said at least one first secondary position 121. If said angle is 90° in the clockwise direction, said at least one permutation unit 150 will order said at least one drive member 160, typically a motor, to move said at least one first indicator 110 and/or said at least one second indicator 120 so that the angle between said at least one first primary position 111 and said at least one second primary position 112 is 90°. The same applies for said at least one second indicator 120, of which the angle between said at least one first secondary position 121 and said at least one second secondary position 122 is 90°. Thus said at least one first indicator 110 indicates the index “1” approximatively in said at least one second primary position 112 and/or said at least one second indicator 120 indicates the index “5” in said at least one second secondary position 122.

Said at least one digital display 140 also permutes 550 between at least one first display mode 141 in said first orientation 131 and at least one second display mode 142 in said second orientation 132.

If in said at least one first display mode 141 in said first orientation 131, said at least one digital display 140 displays the temperature and/or the date for example, in said at least one second display mode 142 in said second orientation 132, said at least one digital display 140 displays a set of indexes 145 such as for example “2” “3” and/or “4”, so that when said display device 100 changes orientation, in particular when said display device 100 is placed on a charging station, the user may know the orientation of said watch and therefore read the time easily during the charging.

It should be specified that the angle between said at least one first primary position 111 and said at least one second primary position 112 and between said at least one first secondary position 121 and said at least one second secondary position 122 may be a multiple of 90° even if said angle between said first orientation 131 and said second orientation 132 is only 50° for example. Indeed, a limit may be established in order to indicate to said at least one permutation unit 150 from which angle the permutation 550 must be carried out.

1. A display device (100) comprising at least one first operating mode (101), at least one second operating mode (102), and:
at least one first indicator (110); said at least one first indicator (110) being configured to indicate the hour in at least one first primary position (111) according to said at least one first operating mode (101) and in at least one second primary position (112) according to said at least one second operating mode (102);
at least one detection member (130); said at least one detection member (130) being configured to detect (530) the passage between a first orientation (131) of said display device (100) and a second orientation (132) of said display device (100); and
at least one permutation unit (150); said at least one permutation unit (150) being configured to permute (550) said at least one first indicator (110) between said at least one first position (111) and said at least one second position (112), when said at least one detection member (130) detects (530) the passage between said first orientation (131) and said second orientation (132).

2. The display device (100) according to claim 1, further comprising at least one digital display (140) comprising at least one first display mode (141) in said first orientation (131) and at least one second display mode (142) in said second orientation (132) and said at least one permutation unit (150) being configured to permute (550) said at least one digital display (140) between said at least one first display mode (141) and said at least one second display mode (142), when said at least one detection member (130) detects (530) the passage between said first orientation (131) and said second orientation (132).

3. The display device (100) according to claim 1, wherein said at least one digital display (140) is configured to display a set of indexes (145) in said at least one second display mode (142) in said second orientation (132).

4. The display device (100) according to claim 1, wherein said at least one first indicator (110) is configured to comprise at least one second indicator (120) configured to indicate the minutes.

5. The display device (100) according to claim 1, wherein said at least one detection member (130) is an accelerometer (130), capacitive sensor (130), inductive sensor (130), resistive sensor (130), optical sensor (130) and/or a power supply detector (130).

6. The display device (100) according to claim 1, wherein said at least one digital display (140) is a LCD, OLED, LED and/or TFT screen (140).

7. The display device (100) according to claim 1, further comprising at least one second indicator (120) configured to indicate the minutes in at least one first secondary position (121) according to said at least one first operating mode (101) and in at least one second secondary position (122) according to said at least one second operating mode (102).

8. The display device (100) according to claim 1, further comprising at least one drive member (160) configured to move said at least one first indicator (110) and/or said at least one second indicator (120).

9. The display device (100) according to claim 1, wherein said at least one permutation unit (150) is configure to calculate the angle between said first orientation (131) and said second orientation (132) and to move said at least one first indicator (110) between said at least one first primary position (111) and said at least one second primary position (112) depending on said angle and/or to move said at least one second indicator (120) between said at least one first secondary position (121) and said at least one second secondary position (122) depending on said angle.

10. A watch (200) configured to operate according to at least one first operating mode (101) and at least one second operating mode (102) and comprising at least one display device (100) according to claim 1.

11. A charging kit (300) comprising at least one watch (200) according to claim 10 and at least one charging station (350) configured to charge or recharge said at least one watch (200).

12. A display permutation method (500) implemented by said display device (100) according to claim 1, said display permutation method (500) comprising:
a detection (530) of the passage between said first orientation (131) of said display device (100) and said second orientation (132) of said display device (100); and
a permutation (550) of said at least one first indicator (110) between said at least one first operating mode (101) and said at least one second operating mode (102), and said at least one digital display (140) between said at least one first display mode (141) and said at least one second display mode (142).

13. The display permutation method (500) according to claim 12, wherein said permutation permutes said at least one digital display (140) between said at least one first display mode (141) and said at least one second display mode (142).

14. The display permutation method (500) according to claim 12, which comprises an indication of the time (510) in said at least one first operating mode (101) and in said at least one second operating mode (102).
